(19) United States
(12) Patent Application Publication
(10) Pub. No.: US 2007/0070046 A1
(43) Pub. Date: Mar. 29, 2007

(54) Sensor-based touchscreen assembly, handheld portable electronic device having assembly, and method of determining touch location on a display panel

(76) Inventors: Leonid Sheynblat, Hillsborough, CA (US); Arnold Jason Gum, San Diego, CA (US)

Correspondence Address: QUALCOMM INCORPORATED, 5775 MOREHOUSE DR., SAN DIEGO, CA, 92121, US

(21) Appl. No.: 11/495,000

(22) Filed: Jul. 27, 2006

Related U.S. Application Data
(60) Provisional application No. 60/719,892, filed on Sep. 21, 2005.

(51) Int. Cl. G09G 5/00

(52) U.S. Cl. 345/173

(57) ABSTRACT

A sensor-based touchscreen assembly for use with a display panel is configured to determine a location on the display panel touched by a user. The sensor-based touchscreen assembly employs at least three sensors mounted on the display panel at different locations. The sensor-based touchscreen assembly further includes a controller coupled to the sensors. The controller is operable to determine a location on the display panel touched by a user by computing a time of difference of arrival (TDOA) of a signal (mechanical or sound wave) emitted from a touch to the sensors.

### BACKGROUND OF THE INVENTION

### Claim of Priority under 35 U.S.C. 119

The present Application for Patent claims priority to Provisional Application No. 60/719,892 entitled Sensor-Based Touchscreen, filed Sep. 21, 2005, and assigned to assignee hereof and hereby expressly incorporated by reference herein.

### Field of the Invention

The present invention relates generally to a touch location determining assembly for determining a touch location, and more particularly to a sensor-based touchscreen assembly for use with a display device. In other aspects, the present invention relates to a handheld portable device having the sensor-based touchscreen assembly and to a method of determining a touch location on a display panel.

### Description of the Related Art

Various types of handheld electronic devices are available and are becoming increasingly more useful as the technology advances. These devices, such as cellular phones, personal digital assistants (PDAs), handheld computers, handheld video game devices and navigations systems, allow users to perform many useful functions. One of the challenges of designing such handheld devices is maximizing the size of the display employed by the device while enabling a user to interact with the device in an efficient manner. One technique employed by many manufacturers is to integrate a touch panel into such portable electronic devices to enable users to touch a display panel to interact with and control certain functions performed by the devices. By using a touch panel, the display area of the handheld device can serve both as a display and a user input interface to enable user interaction with and control of the device functions, enabling incorporation of a larger display panel and reducing the size of the keypad and, in some cases, eliminating the keypad all together.

There are a number of different types of touch panels capable of detecting the location of a display panel touched by a user. For example, some of the existing touch panels employ pressure sensitive type sensors or electrostatic capacity type sensors disposed on the front surface of a display panel. One potential problem associated with such a conventional touch panel is that because it requires a mounting sensor substrate on the entire front surface of a display panel, the sensor substrate covering the display panel can cause images appearing thereon to be duller. Accordingly, additional power may be required to deliver the same brightness as a display panel without such touch panel. Such additional power consumption is particularly undesirable in a handheld electronic device because it can reduce battery life of the handheld device.

As such, there is a need for a touch location determining assembly which is capable of determining a location on a display panel touched by a user without adversely effecting brightness or contrast of the display panel. Additionally, there is a need for a touch location determining assembly which can be incorporated within a handheld electronic device without demanding additional power consumption by the display of the handheld electronic device.

### BRIEF SUMMARY OF THE INVENTION

Described herein are various embodiments of a touch location determining system, such as a sensor-based touchscreen assembly, for determining a location on a display panel touched by a user. The sensor-based touchscreen assembly employs at least three sensors coupled to a display panel at different locations. The sensor-based touchscreen assembly further includes a controller coupled to the sensors. The controller is operable to determine a location on the display panel touched by a user by computing a time of difference of arrival (TDOA) of a signal (e.g., mechanical or sound wave) emitted from a touch to the sensors.

In one embodiment, a touch location determining assembly employs at least three sensors mounted on a rear side of the display panel at different locations. Each of the sensors provides a signal corresponding to a measurement of a touch parameter detected at the respective sensor location. The signals provided by the sensors are processed to determine a touch location. In one embodiment, the touch parameter measured by the sensors is a magnitude of movement detected at the sensor locations. In another embodiment, the touch parameter measured by the sensors is a magnitude of acceleration force detected at the sensor locations. In a further embodiment, the touch parameter measured by the sensors is a magnitude of vibration (shock) motion detected at the sensor locations.

In one aspect of one embodiment, the touch location determining assembly comprises a first motion sensor coupled to the display panel at a first location, a second motion sensor coupled to the display panel at a second location, and a third motion sensor coupled to the display panel at a third location. The first motion sensor is operable to provide a first signal representative of a magnitude of movement detected at the first location. The second motion sensor is operable to provide a second signal representative of a magnitude of movement detected at the second location. The third motion sensor is operable to provide a third signal representative of a magnitude of movement detected at the third location. The touch location can be determined as a function of the first signal, the second signal and the third signal received from the motion sensors.

In another aspect of one embodiment, the touch location determining assembly comprises at least three MEMS (micro-electromechanical systems) accelerometers mounted on a rear side of the display panel. The mounting locations of the accelerometers are selected such that the touch location can be determined by trilaterating the signals generated by the accelerometers. In addition to the accelerometers, the touch location determining system may further comprise a controller and a sensor interface coupled between the accelerometers and the controller. The sensor interface conditions the signals provided by the accelerometers and produces conditioned digitized signals readable by the controller. In one embodiment, the sensor interface comprises a first signal conditioning circuit coupled between the first accelerometer and the controller, a second signal conditioning circuit coupled between the second accelerometer and the controller and a third signal conditioning circuits coupled between the third accelerometer and the controller. In one embodiment, each of the signal conditioning circuits comprises at least one of the following components: an amplifier, a filter and an analog-to-digital converter. Alternatively, the signal conditioning circuit is integrated in the accelerometer.

In a further aspect of the invention, a method is provided for determining a touch location on a display panel. The method comprises receiving a first signal representative of a magnitude of a touch motion detected at a first location of a display panel, receiving a second signal representative of a magnitude of a touch motion detected at a second location of the display panel, and receiving a third signal representative of a magnitude of a touch motion detected at a third location of the display panel. The method further comprises determining a location on the display panel touched by a user as a function of the first signal, the second signal and the third signal. In one embodiment, the method determines the touch location in accordance with the multilateration principle. In another embodiment, the method determines the touch location in accordance with the triangulation principle.

In yet another aspect of the invention, an alternative embodiment of a method for determining a touch location on a display panel is provided. The method comprises determining a first detection time when a touch event is sensed by a first sensor at a first location of a display panel, determining a second detection time when the same touch event is sensed by a second sensor at a second location of the display panel, and determining a third detection time when the same touch event is sensed by a third sensor at a third location of the display panel. The method further comprises determining a location on the display panel touched by a user as a function of the first detection time, the second detection time and the third detection time in accordance with the multilateration principle.

In accordance with one aspect of one embodiment, the sensor-based touchscreen assembly determines the location of the display panel touched with a stylus, a finger or other input device by computing the time difference of arrival (TDOA) of a signal emitted from a touch (e.g., a sound or mechanical wave generated as a result of the touch) to sensors. In a first embodiment, the signal emitted from the touch is a mechanical wave generated as a result of the user touching the display panel with a finger or an input device. In the first embodiment, the sensors employed by the sensor-based touchscreen assembly are accelerometers or movement or shock/vibration sensors for sensing the mechanical waves generated as a result of the user touching the display panel. In a second embodiment, the signal emitted from the touch is a sound wave generated as a result of the user touching the display panel with a finger or an input device. In the second embodiment, the sensors employed by the sensor-based touchscreen assembly are capable of sensing sound waves generated as a result of the user touching the display panel.

### BRIEF DESCRIPTION OF THE DRAWINGS

Embodiments of the invention are illustrated by way of example and not by way of limitation in the figures of the accompanying drawings in which like references indicate similar elements. It should be noted that the references to “an embodiment” or “one embodiment” of this disclosure are not necessarily to the same embodiment, and such references mean at least one.

FIG. 1 is a block diagram of a host system employing a touch location determining assembly in accordance with one embodiment of the invention.

FIG. 2 is a block diagram of the touch location determining assembly in accordance with one embodiment of the invention.

FIG. 3 is a flowchart diagram illustrating operations involved in determining a touch location in accordance with one embodiment of the invention.

FIG. 4 is a flowchart diagram illustrating operations involved in determining a touch location in accordance with an alternative embodiment of the invention.

### DETAILED DESCRIPTION OF THE PREFERRED EMBODIMENTS

In the following description, specific details are set forth in order to provide a thorough understanding of various embodiments of the present invention. However, it will be apparent to one skilled in the art that embodiments of the present invention may be practiced without these specific details. In other instances, well-known hardware and software components, structures and techniques have not been shown in detail in order to avoid obscuring embodiments of the present invention. It should be noted that, as used in the description herein and the claims, the meaning of “in” includes “in” and “on”.

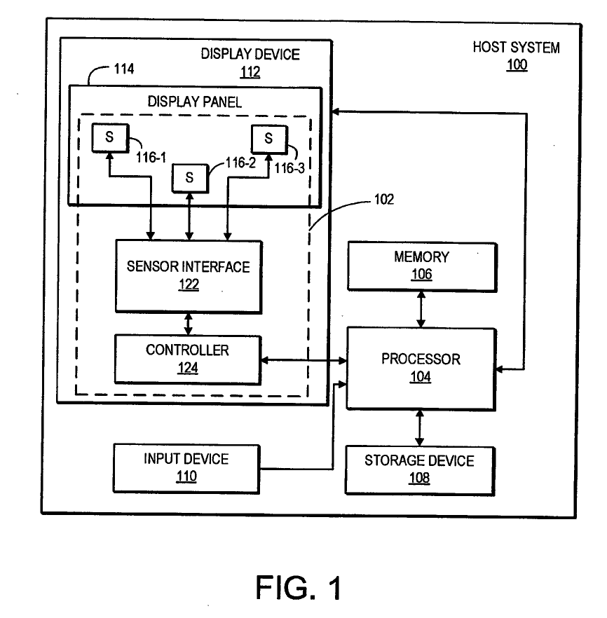

FIG. 1 depicts a block diagram of a host system 100 employing a touch location determining (TLD) assembly 102 according to one embodiment of the invention. The host system 100 may correspond to a portable electronic device, such as a cellular phone, a personal digital assistant (PDA), a handheld computer, a video game device, a personal navigation system or other types of portable electronic devices. The host system 100 may also correspond to a computer system, such as a desktop computer, a notebook computer, a tablet computer or other types of computer systems. In broad sense the host system 100 may correspond to any suitable system that includes a display panel such as flat screen TVs, point of sale device—cash registers, etc.

The host system 100 includes a processor 104 coupled to a main memory 106. Also coupled to the processor 104 are a number of input/output (I/O) devices, including a storage device 108 (e.g., ROM/RAM, hard disk drive, removable memory device), an input device 110 (e.g., keypad, keyboard, pointing device) and a display device 112. The display device 112 may be incorporated within the host system 100. Alternatively, the display device 112 may be a separate device (e.g., desktop computer monitor) which is removably coupled to the host system 100. In one embodiment, the display device 112 is an LCD (liquid crystal display) device to which the TLD assembly 102 is coupled to handle a user's touch inputs. The TLD assembly 102 may be used with other types of display devices, such as a cathode-ray tube (CRT) device, an electroluminescence (EL) display device and a plasma display panel (PDP) display device. The display device 112 includes a display panel 114 on which images, graphics and information can be displayed. The TLD assembly 102 serves as a user control interface. In particular, the TLD assembly 102 detects a location on the display panel 114 touched by a user with a finger or an input instrument (e.g., stylus pen) and outputs touch location information, which may be expressed in the form of, for example, x-y coordinates. The TLD assembly 102 communicates the touch location information to the host processor 104. Alternatively, a user can be presented with a set of objects representing, for example, a menu of items. In such case, the output of the TLD assembly can be the identification information of the object touched. The TLD assembly 102 is capable of being calibrated by asking the user to touch the display panel 114 at a specified location identified on the display panel 114 as a special symbol. Since the input is made from a predetermined and known location the multilateration method can be calibrated by measuring the touch parameters as described above (e.g., magnitude, time, etc).

The host system 100 shown and described with respect to FIG. 1 is an example of a host system configuration to which the TLD assembly 102 according to embodiments of the invention may be implemented. It is understood that embodiments of the TLD assembly 102 shown and described herein are not dependent on any particular type of host system configuration, and thus embodiments of the TLD assembly 102 can be implemented with other suitable host system configurations.

The TLD assembly 102 employs three sensors 116 coupled to the display panel 114. In one embodiment, the TLD assembly 102 comprise a first sensor 116-1 mounted on a rear surface of the display panel 114 at a first location, a second sensor 116-2 mounted on the rear surface of the display panel 114 at a second location, and a third sensor 116-3 mounted on the rear surface of the display panel at a third location. The mounting locations of the sensors 116 are selected so as to allow touch locations to be determined by multilateration. The locations of the sensors 116 are known in terms of the (x, y) coordinates associated with each location. While three sensors 116 are shown and described with respect to FIG. 1, it is understood that the TLD assembly 102 may alternatively employ more than three sensors (e.g., four sensors). Alternatively, less than three sensors can be employed. If a user input is restricted to a single dimension (such as a location on a line) then either two or one sensor may be employed. An exemplary application of such technique can be used to input a relative value between minimum and maximum values. Another example, involves a selection of an object included in a menu represented either as items listed in a column or a row. In general, three sensors are preferred for two dimensional multilateration applications.

Each of the sensors 116-1, 116-2 and 116-3 is operable to measure a touch parameter detected at the sensor location. In one embodiment, the touch parameter measured by the sensors 116 is a magnitude of movement detected at the sensor locations. In this embodiment, the sensors 116 are motion sensors capable of sensing movements associated with a user touching the display panel 114 and generating an electrical signal representative of a magnitude of movement sensed at the sensor locations.

In another embodiment, the touch parameter measured by the sensors 116 is a magnitude of acceleration force detected at the sensor locations. In this embodiment, the sensors 116 comprise MEMS (micro-electromechanical systems) accelerometers capable of sensing an acceleration force associated with a user touching the display panel 114 and generating an electrical signal representative of a magnitude of acceleration force sensed at the sensor locations.

In a further embodiment, the touch parameter measured by the sensors 116 is a magnitude of vibration motion or tapping motion detected at the sensor locations. In this embodiment, the sensors 116 may comprise accelerometers or any other suitable type of motion sensors capable of sensing vibration motion and/or tapping motion associated with a user touching or tapping the display panel 114 and generating an electrical signal representative of a magnitude of vibration motion or tapping motion sensed at the sensor locations.

In a yet further embodiment, the touch parameter measured by the sensors 116 is a time of a vibration motion or tapping motion detected at the sensor locations. In this embodiment, the sensors 116 may comprise accelerometers or any other suitable type of motion/shock/vibration sensors capable of sensing vibration motion and/or tapping motion associated with a user touching or tapping the display panel 114 and generating an electrical signal representative of the detection of vibration motion or tapping motion sensed at the sensor locations. The time of the detection can be used to trilaterate the location of a touch or a tap or other user input motion.

Also included in the TLD assembly are a controller 124 and a sensor interface 122. The sensor interface 122 is coupled between the sensors 116 and the controller 124 to receive signals generated by the sensors 116 and produce signals which are readable by the controller 124. The controller 124 is operable to determine a location on the display panel 114 touched by a user based on signals forwarded by the sensor interface 122. To determine a touch location, the controller 124 processes the signals received from the sensor interface 122 in accordance with multilateration principle. Since multiple sensors 116 measure the same touch event, the precise knowledge of the locations of the sensors 116 allows for multilateration of the location of a user's touch based on the values of the signals received from the sensors. In one embodiment, the touch location computation is carried out by the controller 124 by executing functions implemented by hardware, software, firmware or any combination thereof.

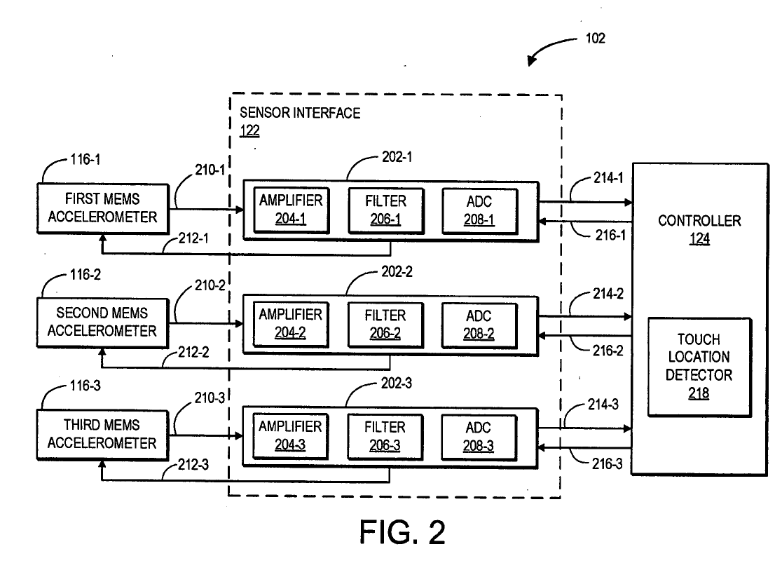

FIG. 2 depicts a block diagram of the TLD assembly 102 in accordance with one embodiment of the invention. The TLD assembly 102 generally comprises at least three MEMS accelerometers 116-1, 116-2 and 116-3, a sensor interface 122 and a controller 124. The accelerometers 116 are disposed on the rear side of a display panel at locations which allow for multilateration of signals generated thereby to recognize touch locations substantially anywhere along the entire display surface of the display panel. Additionally, the accelerometers 116 are preferably mounted to the display panel such that sensing internal components (transducers) of the accelerometers are sensitive to acceleration forces applied to the display panel resulting from users touching the display panel with a finger or an input instrument. Any suitable type of MEMS accelerometers may be used, including piezoresistive type accelerometers, tunneling type accelerometers, capacitive type accelerometers, and thermal type accelerometers. The MEMS accelerometers are available in very small sizes (e.g., 3 mm×3 mm×0.9 mm) and come with a one, a two or a three axes of sensitivity implementations and can be mounted to display panels of various sizes, including small display panels of handheld portable electronic devices.

In one embodiment, the sensor interface 122 comprises a first signal conditioning circuit 202-1 coupled between the first accelerometer 116-1 and the controller 124, a second signal conditioning circuit 202-2 coupled between the second accelerometer 116-2 and the controller 124, and a third signal conditioning circuit 202-3 coupled between the third accelerometer 116-3 and the controller. Each of the signal conditioning circuits 202 includes an amplifier circuit section 204, a filter circuit section 206 and an analog-to-digital converter (ADC) 208. The signal conditioning circuits 202 may be operable to generate a reset signal 212 to reset the accelerometer 116 for subsequent measurements.

In use, the signal conditioning circuits 202 are used to condition signals 210 received from the accelerometers 116 to place the signals in condition to be processed by the controller 124. In particular, a signal 210 generated by the accelerometer 116 is passed through the amplifier and filter circuit sections 204, 206 to generate a filtered amplifier signal. The filtered amplifier signal (i.e., analog signal) is conveyed to the ADC 208, which converts the analog filtered amplifier signal to a digital output signal 214. The controller 124 receives the digital output signals 214-1, 214-2 and 214-3 from the sensor interface 122 and determines a touch location (e.g., x-y coordinate data) as a function of the digital output signals 214-1, 214-2 and 214-3. In one embodiment, the touch location computation is carried out by touch location detector function 218 executed by the controller 124. The controller 124 may be operable to generate a control signal 216 to adjust operating parameters (e.g., gain of amplifier) of the amplifier and filter circuit sections 204, 206 of the signal conditioning circuits 202 if such adjustments are required.

While in the illustrated embodiments, the controller 124 and the host processor 104 are shown and described as being separate components, it should be noted that some or all of the functions carried out by the controller 124 may be implemented by the host processor 104. Such arrangements are within the scope and contemplation of the present invention.

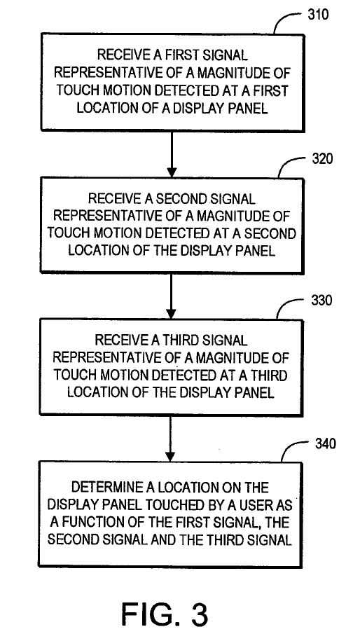

Referring to FIG. 3, a process of determining a touch location in accordance with one embodiment of the invention is shown and described. When the front viewing surface of the display panel is touched or tapped with a finger or an input instrument, the touch causes touch motion to propagate across the display panel. As the touch motion propagates across the display panel, the sensors 116, located at various locations on the rear side of the display panel, are used to measure an intensity (magnitude) of touch motion sensed at each of the sensor locations. The intensity of the touch motion (e.g., force associated with accelerating mass, movement, displacement, shock, vibration) associated with a touch decreases as a function of the travel distance (i.e., distance traveled from the actual touch location to the sensor location). Accordingly, in one embodiment, the touch location is determined based on measurement of the magnitude of touch motion (e.g., acceleration force, force of shock, vibration movement) sensed at the three different locations of the display panel by the respective sensors. In this regard, each of the sensors 116-1 through 116-3 measures a touch motion caused by the user's touch and outputs a signal corresponding to a magnitude of the touch motion measure at the sensor location. The signals output by the sensors 116 are conditioned by the signal conditioning circuits 202-1, 202-2 and 202-3, respectively, to place the signals in condition to be readable by the controller 124..

In block 310, the controller 124 receives a first signal 214-1 output by the first conditioning circuit 202-1 of the sensor interface 122. In one embodiment, the first signal 214-1 is representative of a magnitude of touch motion detected at the location of the first sensor 116-1. Similarly, in block 320, the controller 124 receives a second signal 214-2 output by the second conditioning circuit 202-2 of the sensor interface 122, which is representative of a magnitude of touch motion detected at the location of the second sensor 116-2. Further, in block 330, the controller 124 receives a third signal 214-3 output by the third conditioning circuit 202-3 of the sensor interface 122, which is representative of a magnitude of touch motion detected at the location of the second sensor 116-3. Then in block 340, the controller 124 determines the touch location based on the values of the signals 214 received from the sensor interface 122. Because the precise locations of the sensors 116 are known by the controller, the touch location can be determined based on the touch motion measurements received from the sensors 116 in accordance with the trilateration principle.

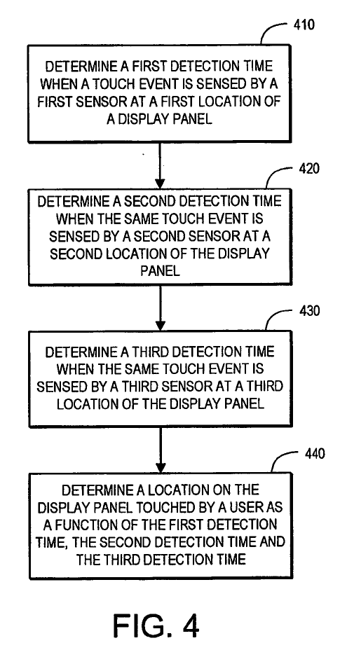

Referring to FIG. 4, a process of determining a touch location in accordance with an alternative embodiment of the invention is shown and described. The amount of time a motion (wave) associated with a touch (or tap) takes to travel from the actual touch location to each respective sensor 116 is dependent on the travel distance. Accordingly, in the alternative embodiment, the touch location is determined based on the precise time (i.e., detection time) when a touch event is detected by each of the sensors. Because the precise locations of the sensors 116 are known by the controller, the touch location can be determined based on exactly when each of the sensors 116 senses the same touch event in accordance with the trilateration principle. In this regard, in the alternative embodiment, each of the sensors 116-1 through 116-3 is capable of detecting a touch event and output a touch detection signal indicating that a touch has been detected. The touch detected signals output by the sensors 116 are processed by the controller 124 to determine the precise time at which each of the sensors has detected the same touch event.

In block 410, the controller 124 determines the precise time (i.e., a first detection time) when a touch event is sensed by the first sensor 116-1 located at the first location of the display panel based on the touch detection signal received from the first sensor 116-1. In one implementation, the touch detection signal includes time information indicating exactly when the touch event was detected. In another implementation, the detection time is determined based on when the touch detection signal is received by the controller. Similarly, in block 420, the controller determines a second detection time when the same touch event is sensed by the second sensor at the second display panel location. Further, in block 430, the controller determines a third detection time when the same touch event is sensed by the third sensor at the third display panel location. Then in block 440, the controller determines a location on the display panel touched by a user as a function of the first detection time, the second detection time and the third detection time in accordance with the trilateration principle.

One of the advantages of the TDP assembly 102 is that because the sensors 116 are mounted on the rear side of the display panel 114, the brightness and/or the sharpness of images appearing on the display panel 114 are not adversely affected by the TDP assembly 102. As noted above, conventional touch panels typically require mounting a sensor substrate on the entire front surface of a display panel, which can cause images appearing on the display panel to be duller and require additional power to deliver the same brightness as a display panel without such touch panel.

As noted above, in one embodiment, the TDP assembly 102 determines a touch location in accordance with the multilateration principle. The term “multilateration” is used to describe a process of locating an object or event by accurately computing the time difference of arrival (TDOA) of a signal emitted from the object or event to three or more receivers or sensors. In the instant case, the emitter of the signal is equivalent to the touch of the screen with a stylus, a finger or other input device which originates the propagation of a sound or mechanical wave which can be sensed by at least one sensor, for example, a sonic or ultrasonic sensor for detecting sound wave or accelerometer or movement or shock/vibration sensor for detecting a mechanical wave. More specifically, in one embodiment, the TDP assembly 102 is configured to determine a touch location by computing the time difference of arrival (TDOA) of a sound or mechanical wave propagating from the actual touch location to each respective sensor 116. In one implementation, the sensors 116 employed by the TDP assembly 102 are accelerometers or movement or shock/vibration sensors for sensing mechanical waves. In another implementation, the sensors 116 employed by the TDP assembly 102 are sonic or ultrasonic sensors capable of sensing sound waves. It is understood that a sound or mechanical wave resulting from a touch of the display panel will arrive at a slightly different time at each respective sensor 116, depending on the travel distances of each sensor from the actual touch. It is further understood that the sensors 116 do not need to know the absolute time at which the sound or mechanical wave resulting from a touch was transmitted. Instead, the TDP assembly 102 can determine the touch location based on the TDOA computation.

While the foregoing embodiments of the invention have been described and shown, it is understood that variations and modifications, such as those suggested and others within the spirit and scope of the invention, may occur to those skilled in the art to which the invention pertains. The scope of the present invention accordingly is to be defined as set forth in the appended claims.

What is claimed is:

1. A sensor-based touchscreen assembly comprising:
at least three sensors coupled to a display panel at different locations; and
a controller coupled to the sensors, the controller operable to determine a location on the display panel touched by a user by computing time of difference of arrival (TDOA) of a signal emitted from a touch to the sensors.

2. The sensor-based touchscreen assembly of claim 1, wherein the at least three sensors comprise:
a first sensor coupled to a display panel at a first location, the first sensor operable to detect the signal emitted from the touch at the first location;
a second sensor coupled to the display panel at a second location, the second sensor operable to detect the signal emitted from the touch at the second location; and
a third sensor coupled to the display panel at a third location, the third sensor operable to detect the signal emitted from the touch at the third location.

3. The sensor-based touchscreen assembly of claim 2, wherein the controller computes TDOA values based signals provided the first sensor, the second sensor and the third sensor, and determines the touch location based on the TDOA values.

4. The sensor-based touchscreen assembly of claim 1, wherein the signal emitted from the touch is a mechanical wave generated as a result of the user touching the display panel with a finger or an input device.

5. The sensor-based touchscreen assembly of claim 4, wherein the sensors are capable of sensing mechanical waves.

6. The sensor-based touchscreen assembly of claim 1, wherein the sensors comprise accelerometers.

7. The sensor-based touchscreen assembly of claim 1, wherein the sensors comprise motion sensors.

8. The sensor-based touchscreen assembly of claim 1, wherein the sensors comprise shock/vibration sensors.

9. The sensor-based touchscreen assembly of claim 1, wherein the signal emitted from the touch is a sound wave generated as a result of the user touching the display panel with a finger or an input device.

10. The sensor-based touchscreen assembly of claim 9, wherein the sensors are capable of sensing sound waves.

11. A handheld portable device comprising:
a display panel; and
a sensor-based touchscreen assembly including at least three sensors coupled to the display panel, the sensor-based touchscreen assembly being operable to determine a location on the display panel touched by a user by computing a time of difference of arrival (TDOA) of a signal emitted from a touch to the sensors.

12. The handheld portable device of claim 11, wherein the signal emitted from the touch is a mechanical wave generated as a result of the user touching the display panel with a finger or an input device.

13. The handheld portable device of claim 12, wherein the sensors are capable of sensing mechanical waves.

14. The handheld portable device of claim 11, wherein the sensors comprise accelerometers.

15. The handheld portable device of claim 11, wherein the sensors comprise motion sensors.

16. The handheld portable device of claim 11, wherein the sensors comprise shock/vibration sensors.

17. The handheld portable device of claim 11, wherein the signal emitted from the touch is a sound wave generated as a result of the user touching the display panel with a finger or an input device.

18. The handheld portable device of claim 17, wherein the sensors are capable of sensing sound waves.

19. The handheld portable device of claim 11, wherein the handheld portable device is a cellular phone.

20. The handheld portable device of claim 11, wherein the handheld portable device is a personal digital assistant (PDA).

21. The handheld portable device of claim 11, wherein the handheld portable device is a video game device.

22. The handheld portable device of claim 11, wherein the handheld portable device is a navigation system.

23. The handheld portable device of claim 11, wherein the handheld portable device is a handheld computer.

24. A system for use with a device having a display panel, comprising:
a first sensor coupled to the display panel at a first location, the first sensor operable to provide a first signal representative of a measurement of a touch parameter detected at the first location;
a second sensor coupled to the display panel at a second location, the second sensor operable to provide a second signal representative of a measurement of the touch parameter detected at the second location;
a third sensor coupled to the display panel at a third location, the third sensor operable to provide a third signal representative of a measurement of the touch parameter detected at the third location; and
wherein a location on the display panel touched by a user is determined based on the first signal, the second signal and the third signal.

25. The system of claim 24, wherein the touch parameter measured by the sensors is a magnitude of movement detected at the sensor locations.

26. The system of claim 24, wherein the touch parameter measured by the sensors is a magnitude of acceleration force detected at the sensor locations.

27. The system of claim 24, wherein the touch parameter measured by the sensors is a magnitude of vibration motion detected at the sensor locations.

28. The system of claim 24, wherein the touch parameter measured by the sensors is a magnitude of shock motion detected at the sensor locations.

29. The system of claim 24, wherein the sensors comprise motion sensors.

30. The system of claim 24, wherein the sensors comprise MEMS accelerometers.

31. The system of claim 24, wherein the sensors are disposed on a rear side of the display panel.

32. The system of claim 24, wherein the touch location is determined in accordance with multilateration principle.

33. The system of claim 24, wherein the touch location is determined in accordance with triangulation principle.

34. The system of claim 24, further comprising:
a controller; and
a sensor interface coupled between the sensors and the controller to process the signals provided by the sensors and produce signals readable by the controller.

35. The system of claim 34, wherein the sensor interface comprises:
a first signal conditioning circuit coupled between the first sensor and the controller, the first signal conditioning circuit including an amplifier circuit;
a second signal conditioning circuit coupled between the second sensor and the controller, the second signal conditioning circuit including an amplifier circuit; and
a third signal conditioning circuit coupled between the third sensor and the controller, the third signal conditioning circuit including an amplifier circuit.

36. A method comprising the steps of:
receiving a first signal representative of a magnitude of a touch motion detected at a first location of a display panel;
receiving a second signal representative of a magnitude of a touch motion detected at a second location of the display panel; and
receiving a third signal representative of a magnitude of a touch motion detected at a third location of the display panel.

37. The method of claim 36, further comprising:
determining a location on the display panel touched by a user based on the first signal, the second signal and the third signal.

38. The method of claim 37, wherein the touch location is determined in accordance with multilateration principle.

39. The method of claim 37, wherein the touch location is determined in accordance with triangulation principle.

40. The method of claim 36, further comprising the steps of:
mounting a first motion sensor to the display panel at the first location to provide the first signal;
mounting a second motion sensor to the display panel at the second location to provide the second signal; and
mounting a third motion sensor to the display panel at the third location to provide the third signal.

41. The method of claim 36, further comprising the steps of:
mounting a first accelerometer to the display panel at the first location to provide the first signal;
mounting a second accelerometer to the display panel at the second location to provide the second signal; and
mounting a third accelerometer to the display panel at the third location to provide the third signal.

42. A system comprising:
a display panel; and
an assembly including at least three motion sensors coupled to the display panel, the assembly operable to determine a location on the display panel touched by a user based on signals generated by at least three motion sensors.

43. The system of claim 42, wherein the motion sensors are disposed on a rear side of the display panel.

44. The system of claim 42, wherein the touch location is determined in accordance with multilateration principle.

45. The system of claim 42, wherein the touch location is determined in accordance with triangulation principle.

46. The system of claim 42, wherein the at least three motion sensors comprise:
a first sensor coupled to the display panel at a first location, the first sensor operable to provide a first signal representative of a magnitude of movement detected at the first location;
a second sensor coupled to the display panel at a second location, the second sensor operable to provide a second signal representative of a magnitude of movement detected at the second location; and
a third sensor coupled to the display panel at a third location, the third sensor operable to provide a third signal representative of a magnitude of movement detected at the third location.

47. The system of claim 46, wherein the assembly further comprises:
a controller; and
a sensor interface coupled between the sensors and the controller to process the signals provided by the sensors and produce signals readable by the controller.

48. The system of claim 47, wherein the sensor interface comprises:
a first signal conditioning circuit coupled between the first sensor and the controller, the first signal conditioning circuit including an amplifier circuit;
a second signal conditioning circuit coupled between the second sensor and the controller, the second signal conditioning circuit including an amplifier circuit; and
a third signal conditioning circuit coupled between the third sensor and the controller, the third signal conditioning circuit including an amplifier circuit.

49. The system of claim 42, wherein the display panel is incorporated within a portable electronic device.

50. The system of claim 42, wherein the display panel is configured for use with a computer system.

51. A method comprising:
determining a first detection time when a touch event is sensed by a first sensor at a first location of a display panel;
determining a second detection time when the same touch event is sensed by a second sensor at a second location of the display panel; and
determining a third detection time when the same touch event is sensed by a third sensor at a third location of the display panel.

52. The method of claim 51, further comprising the steps of:
determining a location on the display panel touched by a user as a function of the first detection time, the second detection time and the third detection time.

53. The method of claim 51, wherein the touch location is determined in accordance with multilateration principle.

54. The method of claim 51, wherein the touch location is determined in accordance with triangulation principle.

55. A sensor-based touchscreen assembly comprising:
at least one sensor coupled to a display panel at a known location; and
a controller coupled to the sensor, the controller operable to determine a location on the display panel touched by a user by computing time of arrival of a signal emitted from a touch to the sensor.

56. A sensor-based touchscreen assembly comprising:
at least one sensor coupled to a display panel at a known location; and
a controller coupled to the sensor, the controller operable to determine an object displayed on the display panel touched by a user by computing time of arrival of a signal emitted from a touch to the sensor.
